(19) United States
(12) Patent Application Publication
(10) Pub. No.: US 2010/0225937 A1
(43) Pub. Date: Sep. 9, 2010

(54) IMAGED PAGE WARP CORRECTION

(76) Inventors: Steven J. Simske, Fort Collins, CO (US); Andrew Bolwell, Santa Cruz, CA (US); Jian Fan, San Jose, CA (US); Timothy Louis Kohler, San Jose, CA (US); Prakash Reddy, Fremont, CA (US); Steven T. Rosenberg, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/399,333

(22) Filed: Mar. 6, 2009

(51) Int. Cl. G06F 15/00; H04N 1/40; G06K 9/40; G06K 9/36

(52) U.S. Cl. 358/1.9; 358/448; 382/254; 382/286

(57) ABSTRACT

A method of correcting warp on an imaged page includes generating projection profiles for pixels on the imaged page and determining a reference baseline based on the projection profiles; calculating a deviation away from the reference baseline for points along a boundary; and mapping the points along the boundary to the reference baseline.

### BACKGROUND

It is desirable to reproduce rare or old books or other documents for the use and enjoyment of many viewers. However, rare/old books or other documents are often fragile and could possibly be destroyed if handled roughly (or at all). Thus, when imaging these materials it is often the case that the page being imaged is not or cannot be pressed flat for fear of damaging the page. In addition, even relatively new books having many pages will generally have some curvature along the page surface, which contributes to distortion in the imaged page. Consequently, the captured image will often include warped objects and/or text or warped lines of text.

It is desirable to efficiently and economically reproduce books and/or documents having minimal or no warp in the final product.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a system configured to correct warp in an imaged page according to one embodiment.

FIG. 2 is a schematic representation of an imaged page of objects including a line of objects warped away from a reference baseline according to one embodiment.

FIG. 3 is a schematic representation of an imaged page of text having a warped line of text.

FIG. 4 is a diagram of a process for correcting warp in an imaged page according to one embodiment.

FIG. 5 is a diagram of a method of correcting warp in an imaged page according to one embodiment.

FIG. 6 is a graph of projection profiles corresponding to the warped line of text illustrated in FIG. 3 according to one embodiment.

FIGS. 7A-7D are diagrams of sub-routines of a process for correcting warp on an imaged page according to one embodiment.

FIG. 8 is a schematic representation of a portion of the warped line of text illustrated in FIG. 3 including calculated quantifiers of local amounts of warp in the line of text according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

It is to be understood that the features of the various exemplary embodiments described herein may be combined with each other, unless specifically noted otherwise.

It is often impractical and/or undesirable to force a page to lie flat when imaging a document for fear of damaging the original document. Moreover, books with many pages will generally have some curvature along the page surface, which ultimately contributes to warp in the imaged page. In addition, other sources of warp include image-aberration(s) arising from lens artifacts that give rise to warp on edges of the captured image.

Embodiments provide a process and a system for correcting warp in objects and/or text of an imaged page. Generally, lines of text are printed in straight parallel lines with the words and the lines separated from adjacent words/lines by white space (or whatever the background is composed of). The system/method for correcting warp on an imaged page described below iteratively measures local deviations away from the expected well ordered text or object on the page by analyzing projection profiles of pixels in the image. If warp is detected, the system/method described below transformatively maps or distorts the warped pixels of the text or object to an appropriate, un-warped baseline.

Embodiments provide a system and a method for determining a projection profile for characters in an imaged page, determining whether warp is present on the page, and correcting the warp by mapping or distorting a warped object or a warped line of text to a reference baseline. Determining the projection profile includes both horizontal and vertical profiling, first to determine the orientation and then to evaluate the projection profiles parallel to the text lines to determine the warp.

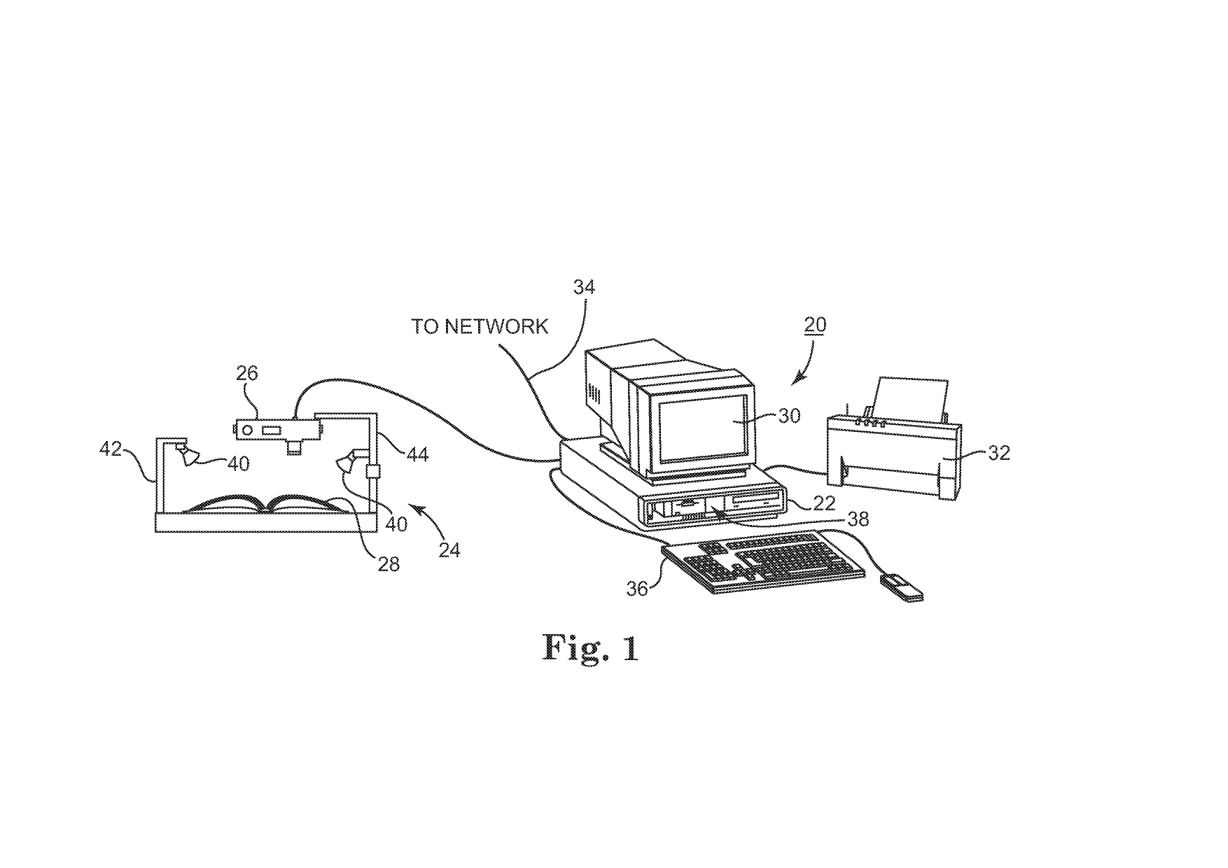

FIG. 1 is a perspective view of a system 20 configured to correct warp in an imaged page according to one embodiment. System 20 includes a computer 22 and a copy assembly 24 including an image receiver 26 communicating with computer 22, where image receiver 26 is configured to capture an image of a page 28 from a book or a document. In one embodiment, page 28 is one page in a multi-page book, and image receiver 26 is a camera or other suitable device configured for capturing an image from page 28 and computer 22 processes the captured image to determine if objects or text on page 28 are warped. In other embodiments, image receiver 26 includes a flatbed scanner configured to image a single page and the capturing/processing of the image is distributed in time and/or in space (e.g., the scan information is stored/processed elsewhere at a later time, or a cloud service or a remote computer processes scanned images from multiple image receivers 26). System 20 quantifies the amount of warp, corrects the warp, and stores the un-warped corrected image to memory in computer 22.

In one embodiment, computer 22 includes a monitor 30 and is connected to one or more peripheral devices, such as printer 32. Monitor 30 is configured to enable viewing of the captured image of page 28 or viewing of the corrected image having the warp removed. In one embodiment, the corrected, un-warped image is saved to memory, or printed via printer 32, and/or transmitted to another device through network connection 34.

In one embodiment, computer 22 includes a central processing unit operating a suitable microprocessor and interfaced with a suitable computer bus or other interface(s) including a scanner, display monitor 30, a connection to a network interface, a connection to a printer 32, a connection to a keyboard 36, a connection to a floppy disc drive, a connection to a flash drive, or other suitable connections to computer 22 at 38. Computer 22 includes a main memory such as a random access memory that interfaces with a computer bus to provide random access memory storage for use by the central processing unit when executing stored programs. The central processing unit is configured to load and execute instruction sequences from a disc or portable memory (or from the network connection 34) into main memory and execute stored programs from the main memory. In one embodiment, computer 22 includes read-only memory that is provided for storing invariant instruction sequences such as start-up instruction sequences or basic input/output operating sequences, for example through keyboard 36.

In one embodiment, copy assembly 24 includes one or more lights 40 attached to a stand 42 and a support 44 attached to camera 26. In one embodiment, lights 40 are configured to illuminate one or more pages 28 of the book and support 44 is configured to enable camera 26 to have a selectively adjustable focus.

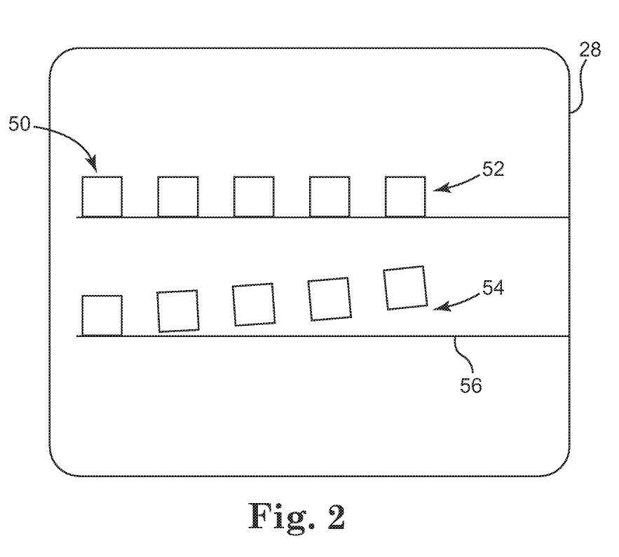

FIG. 2 is a schematic representation of an image of page 28 including imaged objects 50. Warp arises on imaged page 28 particularly when page 28 does not lie flat in a plane parallel to a plane of focus for camera 26 (FIG. 1). The illustrated captured image of page 28 has a set of objects 54 that are warped away from reference baseline 56. Embodiments described herein provide a system and a method for correcting the warp of objects 54 and producing a corrected image of objects 54 transformed or mapped onto baseline 56. In addition, embodiments described below provide a system and a method for correcting warped text, although upon reading this disclosure it will be evident that correcting warped objects is but a subset of the broader capability of system 20 in correcting warped text/objects on page 28.

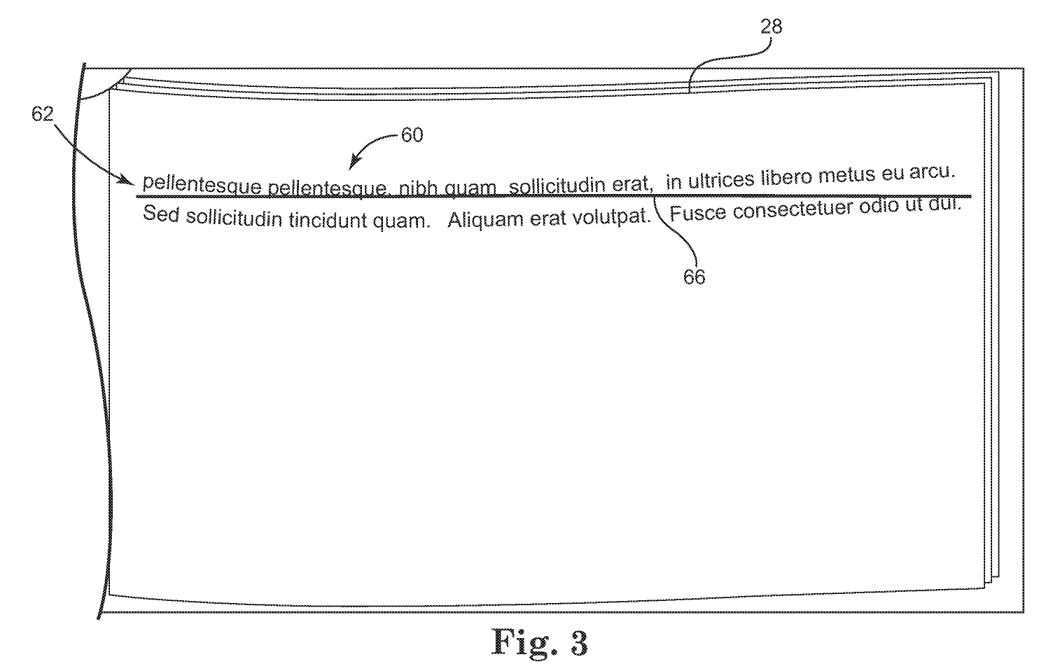

FIG. 3 is a schematic representation of text 60 on imaged page 28 according to one embodiment. Text 60 includes two exemplary lines of text including line 62 that has characters of text warped away from a reference baseline 66. In one embodiment, the pixels of text 60 are rasterized into a binary map, and a projection profile in a direction parallel to a length of the text lines for the rasterized pixels is assembled. A text boundary of the binary pixels is determined that enables calculating a distance between a first black pixel in the text boundary and each edge of the map. Thereafter, angles are calculated between each pixel in the text boundary and each edge of the map, which quantifies that amount of warp to be removed by mapping pixels to the reference baseline.

In one embodiment, non-text regions are segmented from a page before isolation of the text regions. Suitable such document segmentation includes the block segmentation approach of Wahl, Wong, and Casey or the area voronoi diagram approach, or other segmentation methods known in the art. In addition, in some embodiments page skew is identified prior to document segmentation through the use of Hough transforms or other suitable methods known in the art. In the presence of warp, the skew so determine is more likely to be slightly in error. In this case, deskew is employed to increase the efficacy of the dewarp

The presence of greatly differential projection profile behavior in vertical and horizontal directions is indicative of text. Text on a page is characteristically printed in parallel lines. In one embodiment, reference baseline 66 is a linear baseline that is horizontal relative to page 28 such that un-warped lines of text are parallel to baseline 66. The un-warped lines of text have a characteristically uniform projection profile pattern that is identifiable by digital analysis. For example, a projection profile for pixels between two adjacent lines is expected to be formed primarily of background (e.g., white pixels). A projection profile of a cross-section taken laterally through characters of text in line 62 would include multiple peaks corresponding to black pixels in each character of text. In one embodiment, the image processing function of computer 22 includes contrast adjustment and black pixels are those pixels having a pixel value in a range between about 0-25 and white pixels are those pixels having a pixel value between about 240-255. In this regard, thin features, for example text, are defined by gray transitions along the edges of the text or object of interest and appropriately identified and processed as described below.

In one embodiment, iterative processing of projection profiles for text 60 is completed until it is determined where baseline 66 intersects line 62, which indicates where baseline 66 just begins to touch (i.e., is tangent) to pixels of one or more characters of line 62. In the illustrated example, baseline 66 is tangent to line 62 approximately at the word “nibh.” The remaining portion of line 62 is warped with the text of line 62 deviating away from baseline 66. The projection profile across line 62 is sufficiently sensitive to recognize that the line of text underneath line 62 is warped and intersects baseline 66. Embodiments described herein provide a system and a method for quantifying the amount of warp of objects/text present in imaged page 28 and correcting the warp by mapping or transforming the warped object/text onto a baseline 66.

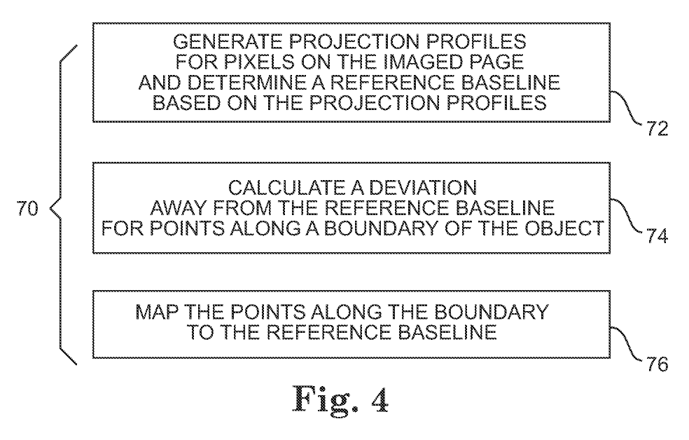

FIG. 4 is a block diagram of a process 70 for correcting warp on an imaged page according to one embodiment. Process 70 includes generating projection profiles for pixels on the imaged page and determining a reference baseline based on the projection profiles at 72. At 74, process 70 includes calculating a deviation away from the reference baseline for points along a boundary of the object. At 76, process 70 includes mapping the points along the boundary to the reference baseline. In one embodiment, the generation of the projection profiles is accomplished in a recursive manner. For example, if there are no gaps between lines of text because of the severity of the warp, the projection profiles are generated by “cutting” the text block into a 2×2 matrix of blocks, and recursively so, until an individual line of text is identifiable.

In one embodiment, the reference baseline is determined by evaluating projection profiles for a rasterized image of pixels to determine a first location at which the baseline touches or intercepts a black pixel in the boundary of the object. As described above, some projection profiles are associated with the white pixels in the background of the image between two lines of text, for example. Embodiments described herein provide an iterative process for determining projection profiles for the imaged page, calculating a reference baseline based on the projection profiles, and calculating a deviation away from the reference baseline for other pixels on the boundary of the imaged object/text.

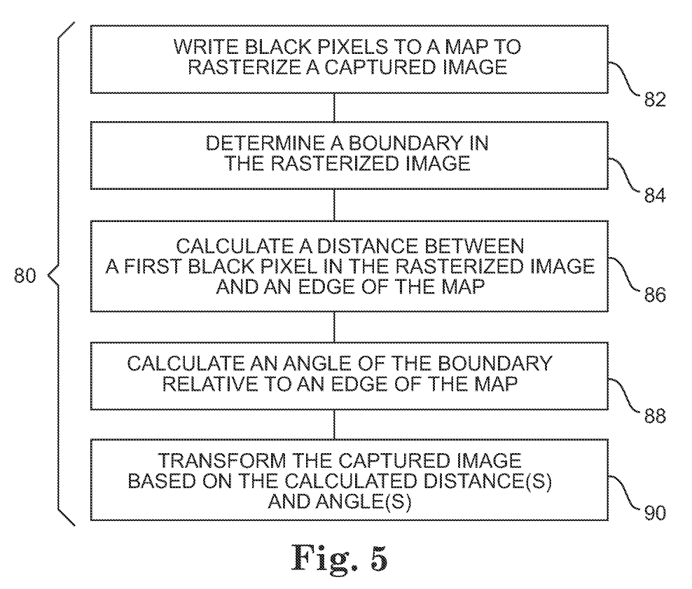

FIG. 5 is a block diagram of a process 80 for correcting warp on an imaged page according to one embodiment. Process 80 includes writing black pixels to a map to rasterize a captured image at 82. At 84, a boundary is determined in the rasterized image. In one embodiment, the boundary is a hull boundary (e.g., a convex hull) and includes black pixels written to a bit map, where the black pixels combine to form a character or a portion of a character in a line of text, for example. At 86, process 80 provides for calculating a distance between a first black pixel in the rasterized image and an edge of the map. In one embodiment, the distance between a first black pixel in the rasterized image and an edge of the map corresponds to an amount that the first black pixel deviates away from the reference baseline (for example as determined at 72 in FIG. 4). At 88, process 80 includes calculating an angle of the boundary relative to an edge of the map. Warped lines of text have a non-zero angle and/or non-zero slope and/or non-constant slope. Lines of text that have a minimum amount of warp or an acceptable amount of warp will have an angle that is substantially 0 (or horizontal and level to other un-warped lines of text and parallel with the reference baseline). At 90, process 80 provides transforming the captured image based on the calculated angles and distances. In one embodiment, the captured image is transformed by distorting the captured image by an amount substantially equal to the amount that the line of text is warped away from the baseline. In one embodiment, the captured image is transformed by mapping the warped line onto the reference baseline according to an equation for a line of best-fit, which linearizes the line of text to the reference baseline.

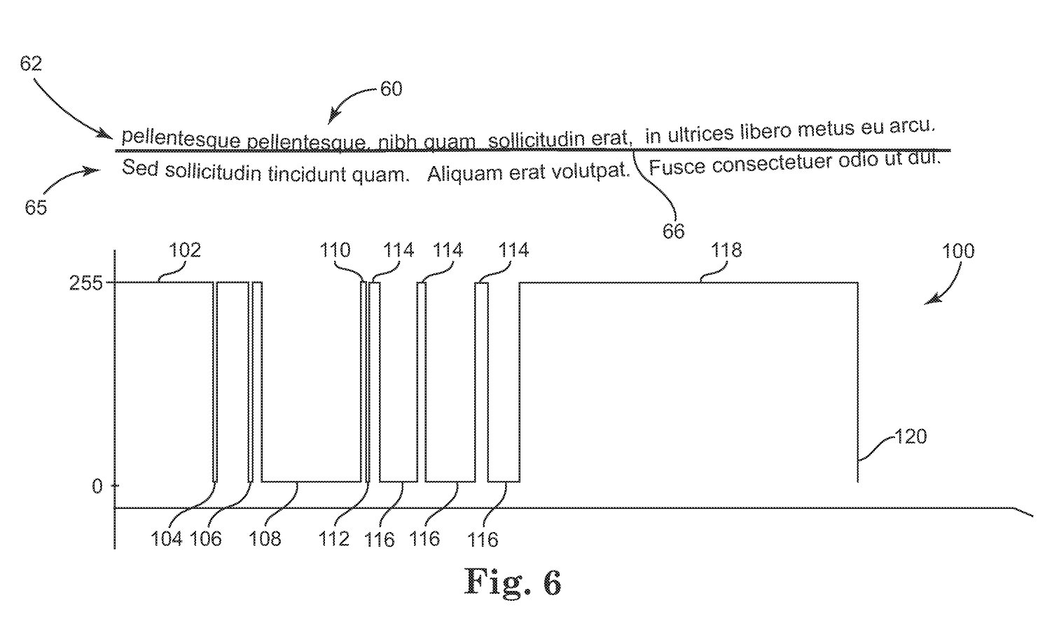

FIG. 6 is a representative graph of a projection profile 100 related to text line 62 illustrated in FIG. 3 according to one embodiment. Projection profile 100 is a plot of binary pixel values where a black pixel has a value of 0 and a white pixel has a value of 255, for example. Other suitable representations of projection profile 100 based on pixel brightness or intensity are also acceptable.

Projection profile 100 is formed as a plot (e.g. a one-dimensional graph where the count at each pixel location across the image is the value of the pixels in the individual projection), which when viewed or “read” from left to right across line 62 creates a graph having local maxima (white background) and local minima (black pixels of text). For example, projection profile 100 includes a segment 102 composed of white background pixels (having the arbitrary value of 0) under the letters “pellentes.” The letter “q” includes a descender (e.g., a tail) that is captured by projection profile 100 as one or more black pixels as indicated at 104. Likewise, the letter “p” includes a descender indicated at 106. In the case of grayscale or color intensity images (e.g., non-binarized images), projection profiles are accumulated in one embodiment based on the amount of blackness. The amount of blackness is determined as the sum over all pixels in the projection of the absolute value of (white-point−pixel gray level). It is to be understood that the space between each letter would also register as background, in which case projection profile 100 would include a local minima for pixel(s) of each letter and a local maxima representing the space between each letter. However, for ease of illustration, the local minima associated with the pixel(s) in the letters have been blended into a single segment. In one embodiment, text is distinguished from the background by employing a moving average to filter the projection profiles with a lobe (e.g., half width) of averaging of approximately 1/40 of an inch.

The projection profile 100 includes a segment 108 that is tangent to the letters “ellentesque, nibh quam sollic.” Thus, segment 108 registers the black pixels in those letters. White space between the word “pellentesque” and the comma is indicated at 110. The black pixel(s) of the comma is indicated at 112 and the space after the comma and before the word “nibh” is indicated at 114. The two spaces between the next three words is also indicated at 114. Segments 116 provide a projection profile oriented at a base of the words “nibh quan sollicitudin.” Thereafter, projection profile 100 diverges away from the black pixels in the text as indicated by segment 118.

Segments 108 and 116 indicate sharp demarcations between black pixels and white pixels, knowledge of which contributes to the determination/location of a reference baseline for the text line 62. In one embodiment, segments such as segments 108, 116 are identified as being tangent to, or just touching, a median height portion of a character of text. Segment 118 indicates a divergence away from black pixels and could represent either the end of the sentence or warp. However, projection profile 100 intersects characters in line 65 as indicated by the local minima at 120, which indicates the presence of black pixels and some level of warp in one or both of lines 62 and 65. In this exemplary manner the structure of projection profile 100 can be employed to determine a reference baseline for line 62 and identify the presence of warp in one or both of text lines 62, 65. The correction of the warp that is identified by projection profile 100 is described below.

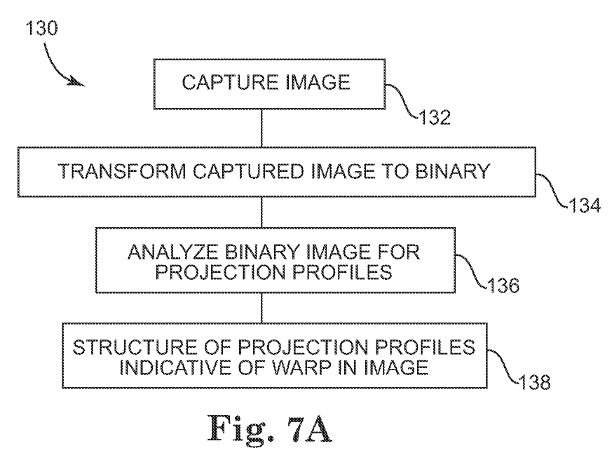

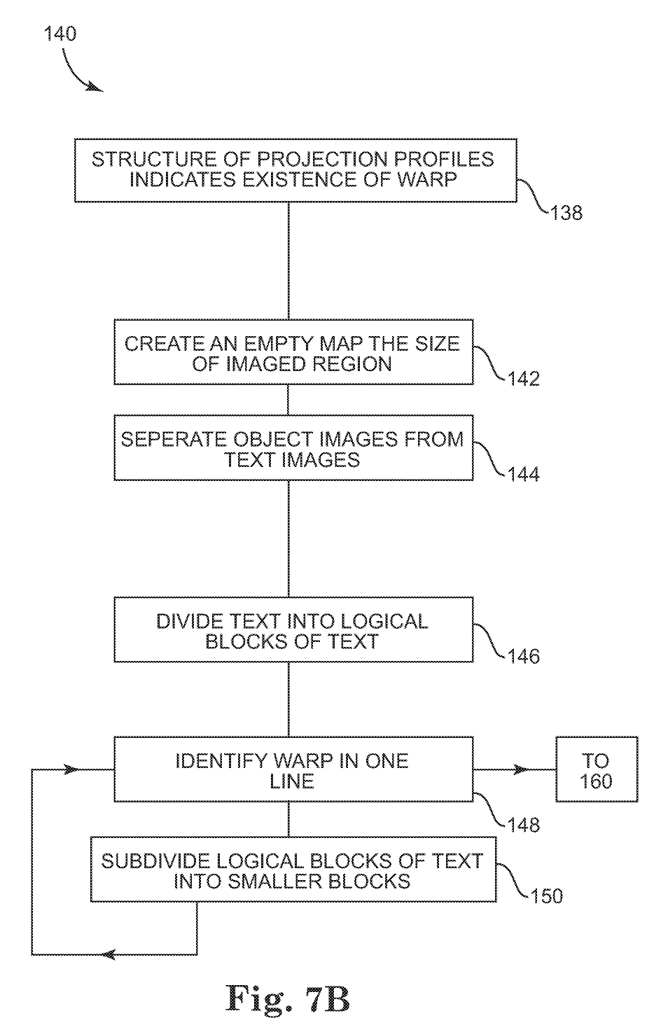

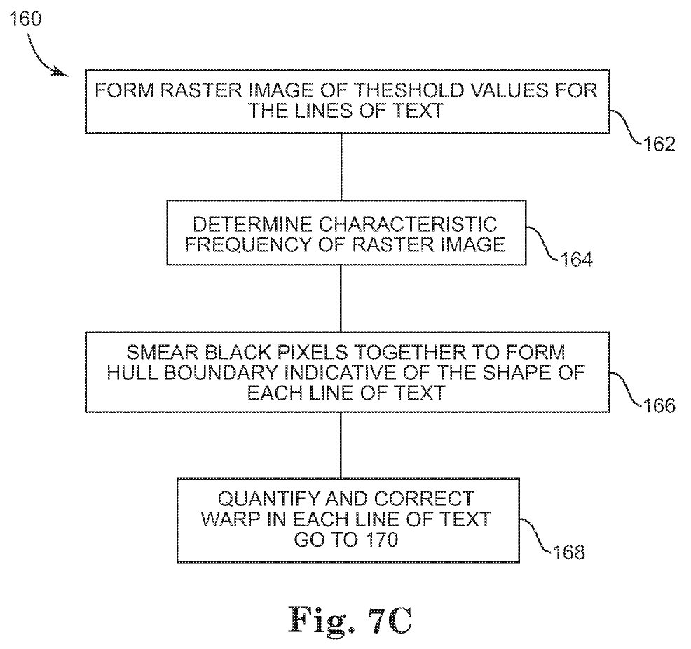

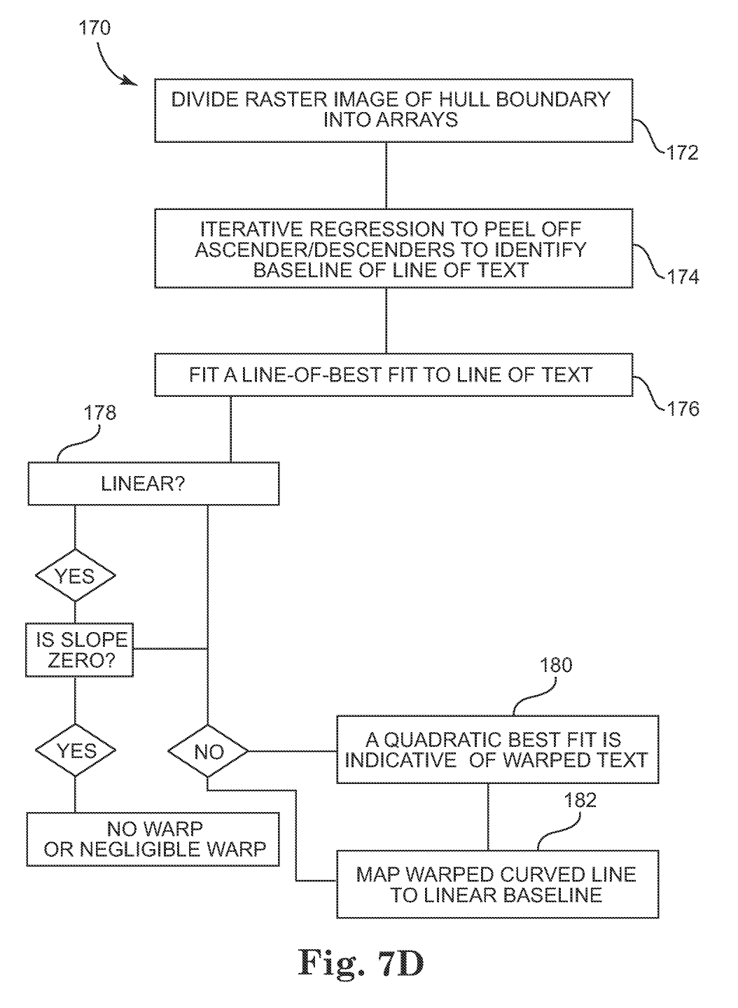

FIGS. 7A-7D are diagrams of embodiments of sub-routines for iteratively correcting warp on an imaged page.

FIG. 7A is a diagram of a process 130 configured to identify structure in projection profile 100 (FIG. 6). Process 130 includes capturing an image at 132. Suitable formats for capturing an image include camera 26 (FIG. 1) or scanners, or cameras employing one or more mirrored surfaces to view into a slight opening formed between two pages in a book. At 134, process 130 includes transforming the captured image to binary. For example, in one embodiment the pixels in the image are assigned binary values, 0 for black pixels and 1 for white pixels. In other embodiments, the image is transformed into binary data with black pixels as 0 and white pixels as 255 or greater values for greater bit depth. In one embodiment, the image is transformed into binary data based on brightness levels or intensity levels. At 136, process 130 includes analyzing the binary image to assemble projection profiles. For example, a projection profile similar to profile 100 is analyzed to identify a reference baseline for one or more portions of text in one or more lines of text. The baseline is characterized as having binary pixel values with a sharp transition between white pixels and black pixels as described above for segment 108 (FIG. 6). At 138, process 130 includes identifying warp in the image based on the structure of the projection profile.

FIG. 7B is a diagram of a process configured to sub-divide logical blocks of text into smaller blocks of text to enable the identification of warp in one line of text. In one embodiment, an empty map is created at 142 having the size of the imaged region. At 144, object images are separated from text images. For example, embodiments provide for un-warping lines of text and un-warping object images. In some embodiments, it is desirable to separately remove the warp from text images before/after removing warp from object images. At 146, the text is divided into logical blocks of text. It is desirable to sub-divide the logical blocks of text down to a level that enables the identification of warp in one line of text as indicated at 148. In one embodiment, a recursive algorithm 150 is employed to iteratively sub-divide a block of text into smaller blocks of text. In this manner, a high level of accuracy in warp detection is enabled by iteratively sub-dividing the block of text into smaller blocks until an amount of warp is detectable (for example by calculating a local angle or a local distance away from a reference baseline as described above). In embodiments where speed is desirable over accuracy, the number of iterations may be reduced. Process 140 moves to action 160 after the amount of warp is quantified by the regressive routine. In one embodiment, it is difficult to know beforehand what the lengths of the top and bottom lines are, or whether the sides are justified, etc., and subdivision is employed just to assess warp accurately.

FIG. 7C is a diagram of action 160 employed to quantify and correct warp in an image text according to one embodiment. Action 160 includes forming a raster image of threshold values for the lines of text at 162. At 164, the characteristic frequency of the raster image is determined. At 166, black pixels are smeared together to form a hull boundary indicative of the shape of each line of text. At 168, warp is quantified and corrected in each line of text according to the actions provided at 170 below.

FIG. 7D is a diagram of actions 170 according to one embodiment. Actions 170 include dividing the raster image of the hull boundary into arrays at 172. In one embodiment, four arrays are created, one each for the top, bottom, left and right sides of the map formed at 142 (FIG. 7B). Distances to the first black pixel from the edges of the map are entered into the array. At 174, one or more iterative regressions are run to disregard ascenders or descenders to identify the baseline of the line of text. In this manner, the body of each letter of text is identifiable by its boundary after the ascenders/descenders have been removed. At 176, a line of best-fit is calculated for the line of text. At 178, the line of best-fit is evaluated to determine if it is linear.

Linear line segments of best-fit may or may not have a slope. Linear line segments of best-fit having slope of zero correspond with text that is not warped or with text that has negligible warp (after the page is deskewed as described above). In general terms, linear line segments of best-fit that have a non-zero slope indicate some amount of warp in the line of text (provided the page is not skewed). The warp is corrected by mapping the curve of best-fit (having a non-zero slope) onto the baseline. At 180, the curve of best-fit is evaluated and determined to be quadratic (i.e., of the form Y=ax²+bx+c). Warped text is corrected by mapping the quadratic line of best-fit to the baseline at 182. In other words, if there is a lack of confidence in the quality of the line of best fit, then the actions at 170 move to a quadratic best fit, and if this provides a significantly better fit for the data, there is confidence that warp is present, and the equation Y=ax²+bx+c is used to correct the warp.

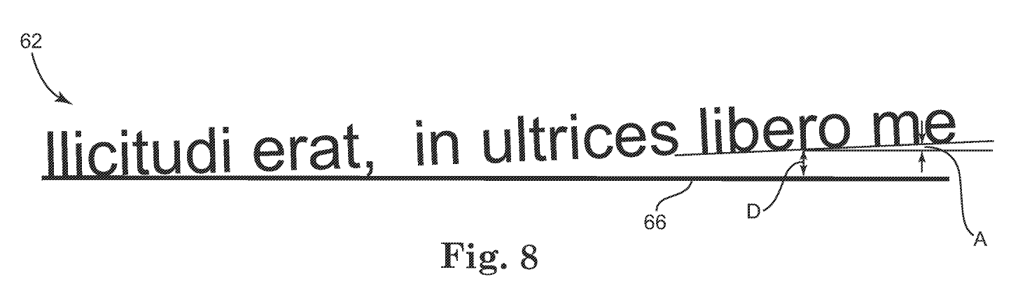

FIG. 8 is a schematic representation of a portion of the warped line 62 of text illustrated in FIG. 3 including calculated quantifiers of local amounts of warp in the line of text according to one embodiment. Although the description of un-warping the text of FIG. 8 is directed to letters of text in line 62, it is to be understood that the method of un-warping the text applies to individual pixels or groups of pixels within each character.

In one embodiment, the iterative regression employed in FIGS. 7A-7D calculates a distance between each black pixel in the text boundary relative to the edge of the map and an angle between each black pixel in the text boundary and each edge of the map. For example, with reference to letter “r” and the word “libero,” the letter “r” is displaced from reference baseline 66 by a distance D and is warped away from reference baseline 66 at an angle A. These distances and angles are calculated as a deviation away from reference baseline 66, for example as indicated at 74 in FIG. 4 and in process 170 of FIG. 7D.

The warp in line 62 of text is corrected by mapping the deviations calculated as the distance D and the angle A back to baseline 66 in a suitable transformative process. In one embodiment, the mapping is pixel-by-pixel in which the pixel associated with the distance D and the angle A is distorted or mapped to baseline 66 by a distance equal to the distance D and is linearized onto baseline 66 by an amount equal to the angle A. In other embodiments, the warp in line 62 of text is not linear but is associated with a higher order best-fit curve. Warp in line 62 is corrected by mapping the quadratic line of best-fit for warped line 62 onto baseline 66. In one embodiment, the calculated distances D to the first black pixel from the edges of the map are employed to correct warp in line 62 by iteratively mapping pixels in the Y direction and then in the X direction to “flatten” out the distance D toward zero.

Embodiments provide a process and a system for correcting warp in objects and/or text of an imaged page that takes advantage of the notion that un-warped lines of text are typically printed in straight parallel lines with the words and the lines separated from adjacent words/lines by white space. The system/method for correcting warp on an imaged page iteratively measures local deviations away from the expected straight/parallel orientation by forming and analyzing projection profiles of pixels in the image. If warp is detected, the system/method transforms or maps or distorts the warped pixels of the text or object to linear un-warped baseline.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of un-warping text/objects on an imaged page as described herein. Therefore, it is intended that this invention be limited only by the claims and the equivalents thereof.

What is claimed is:

1. A method of correcting warp on an imaged page, the method comprising:
generating projection profiles for pixels on the imaged page and determining a reference baseline based on the projection profiles;
calculating a deviation away from the reference baseline for points along a boundary; and
mapping the points along the boundary to the reference baseline.

2. The method of claim 1, comprising imaging a page in a book with a camera and determining a reference baseline by iteratively analyzing brightness values of pixels along rows of pixels through the imaged page.

3. The method of claim 1, wherein generating projection profiles for pixels on the imaged page comprises locating a local minimum in a distribution of brightness values for pixels on the imaged page and assigning the reference baseline to a pixel corresponding to the local minimum.

4. The method of claim 3, wherein the imaged page comprises a warped line of text and the reference baseline comprising a baseline of the warped line of text.

5. The method of claim 4, comprising:
iteratively analyzing each line of text in the page;
identifying a line of text parallel to the reference baseline; and
identifying one or more warped lines of text.

6. The method of claim 4, comprising digitally and iteratively linearizing multiple warped lines of text by iterative transformation of characters in each of the warped lines of text toward their respective baselines.

7. The method of claim 4, wherein mapping the points along the boundary to the reference baseline comprises:
rasterizing binary pixels from the warped line of text to a map;
determining a text boundary of the binary pixels;
calculating a distance between a first black pixel in the text boundary and each edge of the map; and
calculating an angle between the first black pixel in the text boundary and each edge of the map.

8. The method of claim 7, comprising eliminating pixel outliers through one of linear regression analysis and quadratic regression analysis.

9. The method of claim 7, comprising iteratively eliminating pixel outliers, and validating warp in the warped line of text by identifying mismatches in slopes for multiple calculated angles for multiple black pixels in the text boundary.

10. The method of claim 7, comprising:
iteratively calculating distances between black pixels in the text boundary; and
applying a transformation to move each of the black pixels toward the reference baseline by an amount substantially equal its calculated distance.

11. A system configured to correct warp in an imaged page, the system comprising:
a camera configured to capture an image;
computational means communicating with the camera and configured to determine a baseline for a boundary of the image and calculate a deviation value away from the baseline for a first location in the image; and
image modification means configured to linearize the image by distorting the first location in the image toward the baseline by an amount substantially equal to the deviation value.

12. The system of claim 11, wherein the computational means is configured to generate projection profiles of rasterized pixels of imaged lines of text and iteratively calculate an angle for the rasterized pixels relative to the baseline.

13. The system of claim 12, wherein the boundary comprises a hull boundary of rasterized black pixels and the computational means is configured to calculate a distance of the hull boundary away from the baseline.

14. A system configured to correct warp in an imaged page, the system comprising:
a receiver configured to capture an image;
a memory configured to store the image and enable computer executable functions; and
a processor configured to execute the computer executable functions and map projection profiles of pixel brightness values for the captured image and calculate a reference baseline based on the projection profiles.

15. The system of claim 14, wherein the processor is configured to map projection profiles of binary pixel brightness values for lines of text in the captured image, calculate a distance between a first pixel in the text and the linear reference baseline, and calculate an angle between the first pixel in the text boundary and the reference baseline.
